(19) United States
(12) Patent Application Publication
(10) Pub. No.: US 2014/0219884 A1
(43) Pub. Date: Aug. 7, 2014

(54) HIGH EMISSIVITY AND HIGH TEMPERATURE DIFFUSION BARRIER COATINGS FOR AN OXYGEN TRANSPORT MEMBRANE ASSEMBLY

(71) Applicants: Sean M. Kelly, Pittsford, NY (US); Charles Robinson, Lawtons, NY (US); Gervase Maxwell Christie, Amherst, NY (US); Uttam R. Doraswami, Tonawanda, NY (US)

(72) Inventors: Sean M. Kelly, Pittsford, NY (US); Charles Robinson, Lawtons, NY (US); Gervase Maxwell Christie, Amherst, NY (US); Uttam R. Doraswami, Tonawanda, NY (US)

(21) Appl. No.: 14/149,053

(22) Filed: Jan. 7, 2014

Related U.S. Application Data
(60) Provisional application No. 61/749,586, filed on Jan. 7, 2013.

(51) Int. Cl. C01B 13/08

(52) U.S. Cl. CPC C01B 13/08
USPC 422/187

(57) ABSTRACT

An oxygen transport membrane assembly having a coating or overlay system is provided. The overlay or coating system is disposed on the one or more surfaces of the metal containing components within the oxygen transport membrane assembly and comprises a plurality of protective layers providing oxidation resistance, chromium diffusion barrier and high emissivity. The disclosed overlay or coating system may include at least one layer of an aluminum oxide or magnesium-aluminum oxide to provide an effective oxidation resistance and/or chromium diffusion barrier. In addition, the overlay or coating system includes a high emissivity layer such as a high porosity ceramic-oxide layer or an aluminum-phosphate layer including a plurality of carbon encapsulated within the aluminum-phosphate matrix.

### CROSS REFERENCE TO RELATED APPLICATIONS

This application claims priority to and the benefit of U.S. provisional patent application Ser. No. 61/749,586 filed Jan. 7, 2013.

### U.S. GOVERNMENT RIGHTS

This invention was made with Government support under Cooperative Agreement No. DE-FC26-07NT43088, awarded by the United States Department of Energy. The Government has certain rights in this invention.

### FIELD OF THE INVENTION

The present invention relates to a thermally stable and protective overlay system or coatings suitable for use on selected components of an oxygen transport membrane assembly, and more particularly, to a coating or overlay system for reformer components or other metal components of an oxygen transport membrane assembly that reduces oxidation rates of any metal in the components; increases emissivity characteristics of the components and the efficiency of radiation heat transfer within the oxygen transport membrane assembly; and/or acts as a diffusion barrier to limit chromium-species volatilization from the metal components into the oxygen transport membrane.

### BACKGROUND

Oxygen transport membranes function to separate oxygen from air or other oxygen containing gases by transporting oxygen ions through a material that is capable of conducting oxygen ions and electrons at elevated temperatures. When a partial pressure difference of oxygen is applied on opposite sides of such a membrane, oxygen ions will ionize on one surface of the membrane and emerge on the opposite side of the membrane and recombine into elemental oxygen. The free electrons resulting from the combination will be transported back through the membrane to ionize the oxygen. The partial pressure difference can be produced by providing the oxygen containing feed to the membrane at a positive pressure, or by combusting a fuel or other combustible substance in the presence of the separated oxygen on the opposite side of the membrane, or a combination of the two methods. It is to be noted that the combustion of a fuel in the presence of the separated oxygen will produce heat that can be used to raise the temperature of the membrane to an operational temperature at which the oxygen ion transport can occur and also to supply heat to an industrial process that requires heating.

Oxygen transport membranes can utilize a single phase mixed conducting material such as a perovskite to conduct the electrons and transport the oxygen ions. While perovskite materials can exhibit a high oxygen flux, such materials tend to be very fragile under operational conditions involved where a fuel or other combustible substance is used to produce the partial pressure difference. Alternatively, a mixture of materials can be used in which a primarily ionic conductor is provided to conduct the oxygen ions and a primarily electronic conductor is used to conduct the electrons. The primarily ionic conductor can be a fluorite structured material such as a stabilized zirconia and the primarily electronic conductor can be a perovskite. Examples of such mixed electronic and ionic conducting membrane is described in U.S. Pat. No. 8,323,463.

Typically, such mixed electronic and ionic composite oxygen transport membranes include a dense separation layer composed of the two phases of materials, a porous fuel oxidation layer located between the dense separation layer and a porous support layer and a porous surface activation layer located opposite to the porous fuel oxidation layer and on the other side of the dense separation layer. All of these layers are supported on a porous support or porous supporting substrate. The dense separation layer is where the oxygen ion transport principally occurs. Although defects in the dense separation layer can occur that enable the passage of gas through such layer, it is intended to be gas tight and therefore, not porous. Both the porous surface activation layer and the porous fuel oxidation layers are “active”, that is, they are formed from materials that permit the transport of oxygen ions and the conduction of electrons. Since the resistance to oxygen ion transport is dependent on the thickness of the membrane, the dense separation layer is made as thin as possible and therefore must be supported in any case. The porous fuel oxidation layer enhances the rate of fuel oxidation by providing a high surface area where fuel can react with oxygen or oxygen ions. The oxygen ions diffuse through the mixed conducting matrix of this porous layer towards the porous support and react with the fuel that diffuses inward from the porous support into the porous fuel oxidation layer. The porous surface activation layer enhances the rate of oxygen incorporation by enhancing the surface area of the dense separation layer while providing a path for the resulting oxygen ions to diffuse through the mixed conducting oxide phase to the dense separation layer and for oxygen molecules to diffuse through the open pore space to the dense separation layer. The surface activation layer therefore, reduces the loss of driving force in the oxygen incorporation process and thereby increases the achievable oxygen flux. Preferably, the porous fuel oxidation layer and the porous surface exchange layer are formed from the same electronic and ionic phases as the dense separation layer to provide a close thermal expansion match between the layers.

One of the recognized problems associated with such oxygen transport membranes is that when operating in a severe thermal environment, the performance and reliability of the membranes erode over time due to deactivation of the cathode. One of the root causes of cathode deactivation is the diffusion of volatile species, such as chromium oxides, from metal components that are in close proximity to the ceramic membranes and subjected to the same high temperatures of about 900° C. to 1100° C.

Another limitation in many existing oxygen transport membrane assemblies is inefficiency in which radiant heat from the oxygen transport membranes is captured and transferred to support the other heating requirements within the system, such as the endothermic heating requirements of the various catalytic reactions in an oxygen transport membrane based system.

The present oxygen transport membrane assembly overcomes the above-identified problems by providing a multifunctional coating or overlay system to various metal components associated with the oxygen transport membrane assembly, such as catalytic reactor housings to provide a chromium diffusion barrier, oxidation resistance, and high emissivity to enhance the thermal performance and reliability of the oxygen transport membrane assembly.

### SUMMARY OF THE INVENTION

The present invention may be characterized as an oxygen transport membrane assembly comprising: (i) an oxygen transport membrane element configured to separate oxygen from an oxygen containing stream and to combust a fuel or other combustible substance such as a hydrogen containing stream at a permeate side of the oxygen transport membrane element in the presence of the separated or permeated oxygen to generate radiant heat; (ii) a reactor configured to produce a reaction product stream in the presence of the radiant heat, the reactor comprises a reactor structure having one or more surfaces; and (iii) an overlay or coating system disposed on the one or more surfaces of the reactor structure, the overlay or coating system comprising a plurality of protective layers providing oxidation resistance, chromium diffusion barrier and high emissivity.

The overlay or coating system may include at least one layer of an aluminum oxide or magnesium-aluminum oxide of roughly 2 microns to about 5 microns thick to provide an effective oxidation resistance or chromium diffusion barrier or both. In one embodiment, the aluminum oxide or magnesium aluminum oxide may be a diffusion bonded thin layer of aluminum oxide formed by vapor deposition of nickel-aluminide and oxidizing the nickel-aluminide deposited layer. Alternatively, the aluminum oxide layers may be formed by applying a slurry based diffused aluminide coating composition comprising a chromium-aluminum alloy and a halide activator on the reactor structure and curing the aluminide coating to form the at least one aluminum oxide layers.

The overlay or coating system may also or alternatively include a high porosity ceramic oxide layer to provide high emissivity or an aluminum-phosphate layer having a thickness of about 2 microns or less and preferably including a plurality of carbon encapsulated within the aluminum-phosphate matrix to provide chromium diffusion barrier and high emissivity.

The reactor structure may be a metal or ceramic assembly wherein the interior surfaces are coated with an oxidation resistant layer. In addition to the reactor structure, the oxygen transport membrane assembly may also include other metal containing components, such as gas feed assembly, a manifold, an adaptor, or a gas connector. Preferably, the metal containing components includes a coating or overlay system that includes an oxidation resistant layer or a chromium barrier layer or both. In particular, the interior surfaces of the reactor structure, which may be ceramic or metal preferably include one or more protective layers such as an oxidation resistant layer or other protective layers that mitigate adverse reactions of any ceramic materials or catalytic materials on the interior of the reactor such as steam-induced reactions.

The oxygen transport membrane assembly with the present coating or overlay system is particularly useful where the reactor structure is a catalyst containing reformer tube configured to produce a synthesis gas product stream from a feed stream in the presence of the radiant heat from the oxygen transport membrane tubes. Alternatively, the reactor structure may be a heating tube configured to produce a heated gas product stream from the radiant heat from the oxygen transport membrane tubes.

### BRIEF DESCRIPTION OF THE DRAWINGS

While the specification concludes with claims distinctly pointing out the subject matter that applicants regard as their invention, it is believed that the invention will be better understood when taken in connection with the accompanying drawing in which:

FIG. 1 is an illustration of a radial based configuration of an oxygen transport membrane assembly;

FIG. 2 is an illustration of a panel based configuration of an oxygen transport membrane assembly, including a first panel of oxygen transport membrane tubes and an adjacent second panel of reforming reactor tube elements;

FIGS. 3A and 3B show further details of the oxygen transport membrane assembly of FIG. 2 depicting an individual oxygen transport membrane tube (FIG. 3A) and a plurality of oxygen transport membrane tubes arranged in a first panel (FIG. 3B), respectively; and

FIGS. 4A and 4B show further details of the oxygen transport membrane assembly of FIG. 2 depicting an individual reactor tube element (FIG. 4A) and a plurality of reactor tube elements arranged in a second panel (FIG. 4B), respectively.

### DETAILED DESCRIPTION

To increase the operating service life of oxygen transport membrane assemblies, it has been found that coating systems or overlay systems deposited on metal components in close proximity to the oxygen transport membranes reduce the oxidation rates of the metal in the metal components and act as a diffusion barrier to limit the formation of volatile chromium oxides causing degradation in the oxygen transport membrane by means of cathode deactivation.

It has also been found that selected high emissivity coatings or overlay systems deposited on reactor components in close proximity to the oxygen transport membranes can be used to increase the efficiency of radiation heat transfer required by the oxygen transport membrane based system. Emissivity is the ratio of total radiative output from a body per unit time per unit area to that of a black body at specific temperatures.

For example, in an oxygen transport membrane based reactor disclosed in U.S. Pat. Nos. 6,296,686 and 8,349,214 or an oxygen transport membrane based advanced power system disclosed in U.S. Pat. Nos. 7,856,829 and 8,196,387, overlay coating systems are needed on the metal reformer components that reduce oxidation rates of the metal, increase the emissivity to increase the efficiency of radiation heat transfer, and act as a diffusion barrier to limit chromium-species volatilization causing cathode deactivation in the oxygen transport membrane elements.

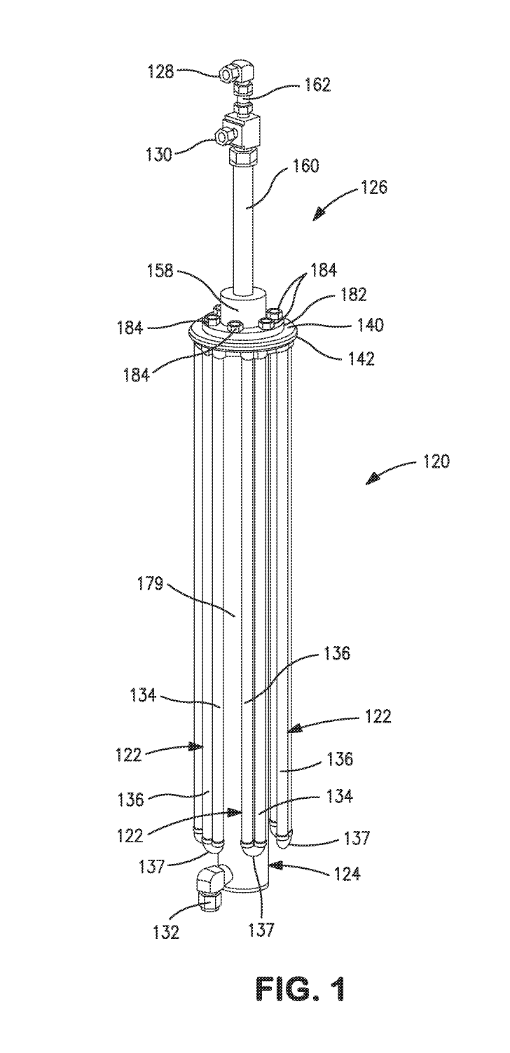

Turning to FIG. 1, there is shown an oxygen transport membrane assembly 120 used in the production of synthesis gas, which includes a reformer tube 124 and other ceramic or metal parts suitable for applying the present high emissivity and diffusion barrier coatings or overlay system. The oxygen transport membrane assembly 120 includes a plurality of oxygen transport membrane elements or tubes 122 that surround a central reactor tube 124 or reformer tube that contains a catalyst to promote the steam methane reforming reaction needed to produce a synthesis gas. In the oxygen transport membrane based synthesis gas system, it is important that the positioning of the oxygen transport membrane elements or tubes 122 with respect to the catalytic reactors or reformer tubes 124 be optimized for radiation heat transfer purposes. In other words, from a radiation heat transfer aspect, the catalytic reactors or reformer tubes 124 must be in “view” of the oxygen transport membrane elements or tubes 122.

The oxygen transport membrane assembly of FIG. 1 includes a feed assembly 126 that includes an inlet 128 for a heated reactant stream and is designed to mix such heated reactant stream with the a heated combustion product stream produced when a fuel or other combustible substance such as a hydrogen containing stream reacts with the transported oxygen on the permeate side of the oxygen transport membrane tubes. Additionally, an inlet 130 is provided for introducing a hydrogen containing stream or other fuel to the permeate side of the oxygen transport membrane tubes 122. Further, the oxygen transport membrane tubes 122 have the permeate side within the tubes while the exterior surfaces of such oxygen transport membrane tubes 122 serve as the retentate side. The synthesis gas stream is discharged from an outlet 132 to the reactor or reformer tube 124. The illustrated oxygen transport membrane assembly 120 includes an arrangement of multiple or paired ceramic oxygen transport membrane tubes 122, with each group or pair comprising an inlet section 134 and an outlet section 136. The oxygen transport membrane tubes 122 are connected at one end by a “U” shaped pipe-like adaptors or bends 137 and connected at the other end to a manifold via thru-block gas connectors.

The illustrated oxygen transport membrane assembly includes numerous assembly parts such as gas outlets 132, adaptors, 137, connectors, as well as the feed assembly 126 (including inlets 128, 130 and feed tubes 160, 162) and gas manifold (including plenum 158; plates 140, 142; and other parts e.g. flange 184, nuts 182, studs, etc.) Many of such parts used in the illustrated oxygen transport membrane assembly may be made of ceramic materials, metal materials or combinations thereof. As discussed in more detail below, coating such metal containing components using the present coating or overlay system is advantageous and enhances the system reliability and performance.

In all illustrated embodiments, the oxygen transport membrane tubes are preferably comprised of a multilayered structure comprising a porous surface exchange layer; a mixed phase oxygen ion conducting dense ceramic separation layer; an intermediate porous layer; and a porous support. The dense ceramic separation layer is preferably capable of conducting oxygen ions and electrons to separate oxygen from an oxygen containing feed and preferably comprises a mixture of a fluorite structured ionic conductive material and electrically conductive perovskite materials to conduct the oxygen ions and electrons, respectively. The porous surface exchange layer or air activation layer is disposed on the outer surface of the oxygen transport membrane tube adjacent to the dense ceramic separation layer. The porous surface exchange layer preferably has a porosity of between about 30 and 60 percent functions to ionize some of the oxygen in the feed. The oxygen that is not ionized at and within the porous surface exchange layer will typically ionize at the adjacent surface of the dense ceramic separation layer. The porous support layer is disposed on the inner surface of the oxygen transport membrane tube and is comprised of a fluorite structured ionic conducting material having a porosity of greater than about 20 percent and a microstructure exhibiting substantially uniform pore size distribution. The intermediate porous layer is often referred to as a fuel oxidation layer and is disposed between the dense ceramic separation layer and the porous support. Like the dense separation layer, the intermediate porous layer is also capable of conducting oxygen ions and electrons to separate the oxygen from the feed.

When a partial pressure difference of oxygen is applied on opposite sides of the membrane, oxygen ions will ionize on one surface of the membrane and emerge on the opposite side of the membrane and recombine into elemental oxygen. The free electrons resulting from the combination will be transported back through the membrane to ionize the oxygen. The partial pressure difference can be produced by providing the oxygen containing feed to the membrane at a positive pressure or by supplying a combustible substance to the side of the membrane opposing the oxygen containing feed or a combination of the two methods.

In the illustrated embodiments of the oxygen transport membrane assembly, an oxygen containing feed such as a feed air stream is contacted on the retentate side or outer surface of the tubular composite oxygen transport membrane where it contacts the porous surface exchange layer which ionizes some of the oxygen in the feed air stream. Oxygen is also ionized at the adjacent surface of the dense ceramic separation layer. The oxygen ions are transported through the dense ceramic separation layer to intermediate porous layer to be distributed to the pores of the porous support. Some of the oxygen ions, upon passage through the dense ceramic separation layer will recombine into elemental oxygen. The recombination of the oxygen ions into elemental oxygen is accompanied by the loss of electrons that flow back through the dense ceramic separation layer to ionize the oxygen at the opposite surface.

At the same time, a combustible substance, for example a hydrogen and carbon monoxide containing synthesis gas, is contacted on the permeate side or inner surface of the oxygen transport membrane tube. The combustible substance enters the pores of the porous support, contacts the transported oxygen and burns through combustion supported by the transported oxygen. Optionally, the combustion may be further promoted by a catalyst that may be present in the form of catalyst particles incorporated into the porous support. The presence of combustible fuel on the permeate side of the oxygen transport membrane, provides a lower partial pressure of oxygen. This lower partial pressure drives the oxygen ion transport as discussed above and also generates heat to heat the dense ceramic separation layer, the intermediate porous layer and the porous surface exchange layer up to an operational temperature at which the oxygen ions will be conducted.

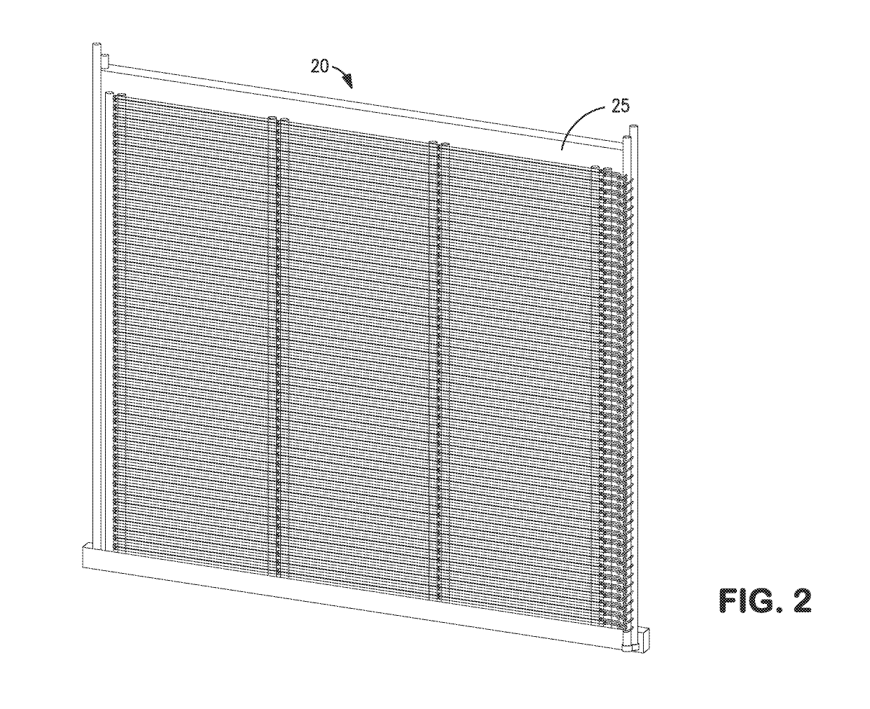

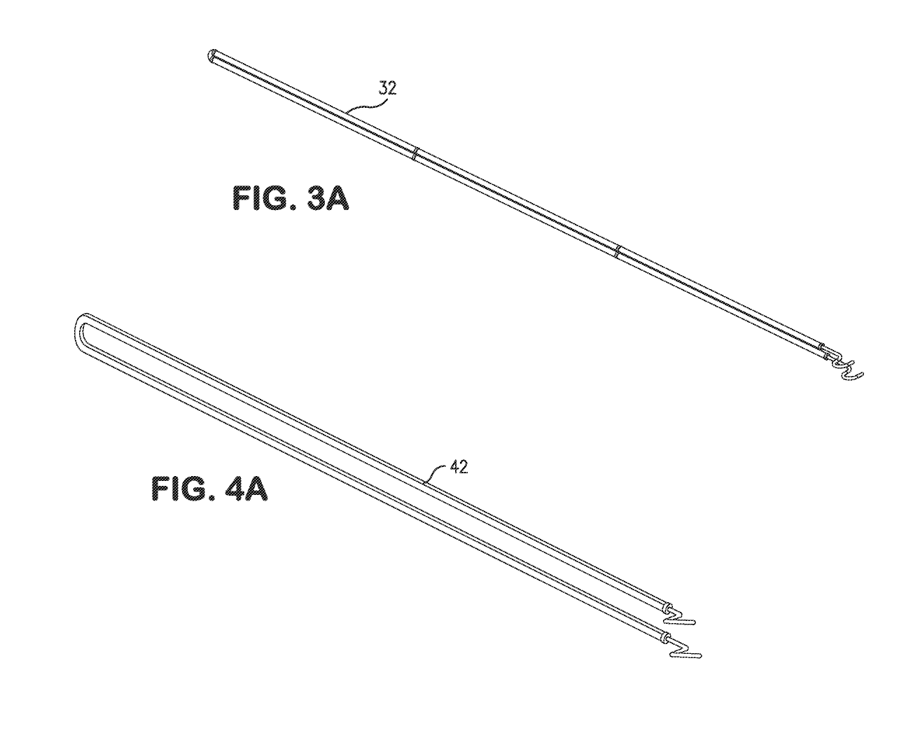

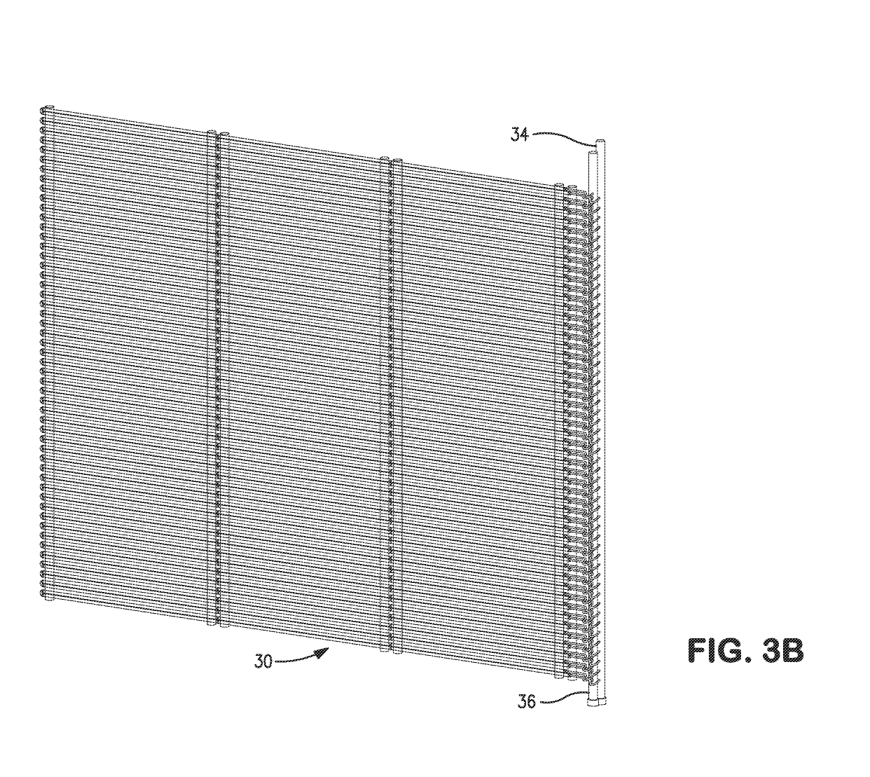

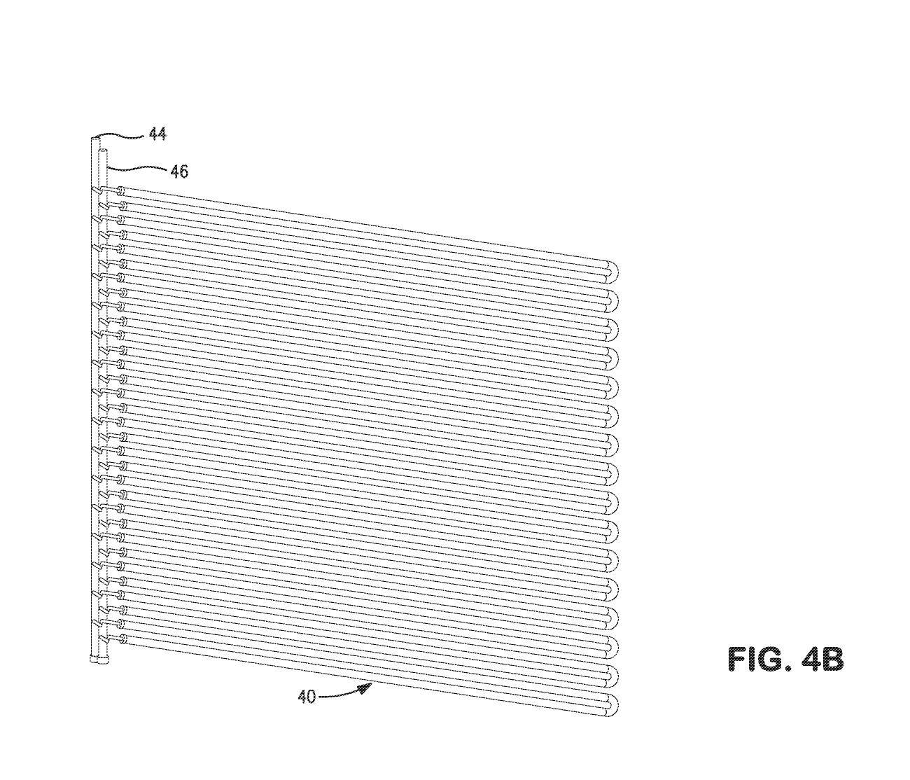

Turning to FIGS. 2, 3A, 3B, 4A, and 4B, the co-planar configuration of oxygen transport membrane assembly 20 is shown that includes a first panel 30 of oxygen transport membrane tubes 32 and an adjacent second panel 40 of reactor tubes 42 disposed within an assembly frame 25. The oxygen transport membrane assembly 20 also includes a first intake manifold 44 with associated seals, connectors and other metal or ceramic components to allow for a flow of a feed stream through the reactor tubes 42 and a second intake manifold 34 with associated seals, connectors and other metal or ceramic components to allow for the flow of a hydrogen containing gas through the ceramic oxygen transport membrane tubes 32 to facilitate the reactively driven oxygen ion transport, described above. In addition, the oxygen transport membrane assembly 20 further comprises exit manifolds (36, 46) configured to withdraw the product stream from the plurality of reactor tubes and configured to withdraw the effluent stream from the plurality of oxygen transport membrane tubes. The preferred arrangement of oxygen transport membrane tubes 32 is a first panel 30 comprising a plurality of parallel oxygen transport membrane tubes 32 shown in FIGS. 3A and 3B adjacent to a second panel 40 comprising plurality of straight rows of reactor tubes 42 as shown in FIGS. 4A and 4B. This multiple panel arrangement of oxygen transport membrane tubes and reactor tubes improves the surface area ratio, view factor and radiative heat transfer efficiency between the different tubes.

In a preferred embodiment, the reactor tubes are catalyst containing reformer reactor tubes configured to produce a synthesis gas product stream from a feed stream of natural gas and steam in the presence of the radiant heat from the oxygen transport membrane tubes. In an alternate embodiment, the reactor tubes are simply heating tubes configured to produce a heated product stream such as heated synthesis gas or steam from the radiant heat from the oxygen transport membrane tubes.

To effectively operate the oxygen transport membrane assembly, sufficient thermal coupling or heat transfer between the heat-releasing ceramic oxygen transport membrane tubes and the heat-absorbing reactor tubes is required. In the illustrated embodiments, the heat transfer between the ceramic oxygen transport membrane tubes and the adjacent reactor tubes is predominantly through the radiation mode of heat transfer whereby surface area, surface view factor, surface emissivity, and non-linear temperature difference between the tubes are critical elements to the thermal coupling. Surface emissivity and temperatures are generally dictated by tube material as well as the reaction requirements. The surface area and radiation view factor are generally dictated by tube arrangement or configuration of the tubes within each oxygen transport membrane assembly. To enhance the surface emissivity of the tubes, it has been found that certain high emissivity coatings may be applied to certain portions of the tube surfaces

In a preferred embodiment of the present coating or overlay system for an oxygen transport membrane assembly, one or more coating underlayers comprising a bonding layer, a diffusion barrier layer, and/or an oxidation resistant layer is deposited on the surface of the metal component, such as the illustrated central reformer tube. These underlayers are followed by a high emissivity layer or surface treatment optionally deposited on the underlayers, where a high emissivity of the component is required, as is the case of the reactor tubes (i.e. gas heating tubes or reformer tubes) used in selected oxygen transport membrane based systems, such as synthesis gas reactors, gas heating reactors and/or advanced power cycle systems.

In the illustrated embodiments of the oxygen transport membrane assembly, the reactor tubes are preferably formed of a chromium-containing metal, for instance, stainless steel or a nickel-based superalloy. In such cases, the present multifunctional coating or overlay system is applied to the exterior surfaces of the reactor tubes and serves as a diffusion barrier layer to prevent chromia migration and subsequent volatilization and also provides high emissivity. The importance of the diffusion barrier layer is to prevent volatilized chromia species from reacting with oxygen transport membrane tubes and degrade the performance thereof through cathode deactivation. Such a chromia diffusion barrier is also useful and can be applied to other metal components in the oxygen transport membrane assembly such as the manifolds, frame, valves or connectors.

In one embodiment, the diffusion barrier coating or surface treatment comprises a dense aluminum-oxide layer or spinel such as (Mn_{0.5}Co_{0.5})₃O₄ that provides both oxidation resistance and a chromia diffusion barrier at the surface of the metal component. Coating the metal component with a high aluminum content alloy material, preferably having more than about 3 percent aluminum, forms an aluminum oxide layer when the coated component is exposed to a high-temperature atmosphere containing oxygen. For example, a nickel-aluminide (Ni₃Al) layer applied in a gas phase diffusion process creates a uniform, dense, and metallically bonded layer on the surface of the metal component. When exposed to an oxidizing atmosphere at high temperature, a protective layer of aluminum oxide forms on the surface of the metal component creating the chromia diffusion barrier.

An effective chromium species diffusion barrier layer has been identified as GP-275 supplied by Hitemco of Old Bethpage N.Y. This coating or surface treatment is preferably applied via high-temperature vapor deposition of nickel-aluminide which is then oxidized to form a diffusion bonded thin layer of aluminum oxide at the surface of the metal component. The applied diffusion barrier layer preferably has a thickness of about 1 microns to about 10 microns, and more preferably between about 2 microns to about 5 microns.

A more preferable diffusion barrier layer is a slurry based diffused aluminide coating composition comprising an aluminum-rich intermetallic compound, such as a chromium-aluminum alloy, and a halide activator. An example of such slurry based diffused aluminide coating is SermAlcote™ 2525 commercially available from Praxair Surface Technologies. The SermAlcote™ 2525 coatings may be applied using techniques generally described in U.S. provisional patent application Ser. No. 61/901,573, the disclosure of which is incorporated by reference herein.

As mentioned above, the reactor tube of the illustrated oxygen transport membrane assembly is thermally coupled to the oxygen transport membrane tubes through radiation heat exchange as a dominant mode. The emissivity of the reactor tube surface is an important factor in the efficiency of this coupling. Base metal, aluminide or aluminum-oxide coatings generally have surface emissivities that are generally too low and could limit the heat transfer efficiency of the oxygen transport membrane assembly. Therefore, in addition to diffusion barrier layers discussed above, a stable, high temperature, high emissivity coating or surface treatment is also be applied to the reactor tubes.

An effective high emissivity surface treatment has been identified as Cerablak® family of coatings available from Applied Thin Films, Inc. (ATFI) of Evanston, Ill. The Cerablak® surface treatment is a non-crystalline phase, high temperature compatible aluminum-phosphate network optionally containing nano-sized carbon black particles encapsulated within the aluminum phosphate network. The high emissivity layer can be applied by spraying or dipping followed by thermal curing. The Cerablak® surface treatment preferably has an applied thickness of up to about 2 microns and demonstrates a high emissivity due to the presence of the carbon black particles.

It should be noted that the Cerablak® surface treatment also provides a high degree of oxidation resistance and can also function as an effective chromium species diffusion barrier. To that end, one or more layers of the Cerablak® surface treatment, with or without the encapsulated carbon black particles, can be applied to the metal or ceramic reactor tubes used in oxygen transport membrane based systems to provide the present multifunctional overlay system.

Alternatively, the high emissivity coating or layer may be a porous cerium-oxide containing coating or layer or other high porosity ceramic-oxide coating or layer applied to the exterior or outer surface of the reactor tube. The cerium-oxide or other ceramic-oxide containing coating or layer provides a higher emissivity at the surface of the reactor tube and also tends to minimize adverse interactions with the oxygen transport membrane tubes. Techniques for controlling the porosity of the high emissivity coatings and particularly ceramic-oxide based coatings are generally described in U.S. patent application Ser. No. 13/720,571 the disclosure of which is incorporated by reference herein.

Where ceramic materials such as silicon carbide (SiC) tubes or silicon carbide toughened aluminum, are used in the reactor tubes, protective coatings or surface treatments such as the Cerablak® family of coatings may also be used to mitigate the reduction of the ceramic materials or steam-induced reactions in the ceramic materials on the process-side or synthesis gas of the reformer tubes. In addition, for both ceramic or metal reactor tubes where a ceramic washcoated catalyst is used, the Cerablak® surface treatments can be applied to the inside of the tubes (i.e. synthesis gas side). Such surface treatments may prevent steam attack, reduction, or carburization of the tube material and provided increased stability and adhesion of the washcoated catalyst.

While the present invention has been characterized in various ways and described in relation to preferred embodiments and preferred coating materials, as will occur to those skilled in the art, numerous, additions, changes and modifications thereto can be made to the present method without departing from the spirit and scope of the present invention as set forth in the appended claims.

What is claimed is:

1. An oxygen transport membrane assembly comprising:
an oxygen transport membrane element configured to separate oxygen from an oxygen containing stream contacting a retentate side of the oxygen transport membrane element and to combust a fuel or other combustible substance at a permeate side of the oxygen transport membrane element in the presence of permeated oxygen thereby to generate radiant heat;
a reactor configured to produce a product stream in the presence of the radiant heat, the reactor comprising a reactor structure having one or more surfaces; and
an overlay or coating system disposed on the one or more surfaces of the reactor structure, the overlay or coating system comprising a plurality of protective layers providing oxidation resistance, chromium diffusion barrier and high emissivity;
wherein the plurality of protective layers comprises: (i) at least one an aluminum oxide layer to provide the oxidation resistance or the chromium diffusion barrier or both; and (ii) at least one layer of a high emissivity material selected from the group consisting of aluminum-phosphate having a plurality of carbon encapsulated therein or a high porosity ceramic oxide material configured to provide high emissivity.

2. The oxygen transport membrane assembly of claim 1 wherein the aluminum oxide layer has a thickness of about 2 microns to 5 microns.

3. The oxygen transport membrane assembly of claim 1 wherein the aluminum oxide layer further comprises a magnesium-aluminum oxide layer.

4. The oxygen transport membrane assembly of claim 1 wherein the at least one aluminum oxide layer further comprises one or more diffusion bonded thin layers of aluminum oxide formed by vapor deposition of nickel-aluminide and oxidizing the nickel-aluminide deposited layer.

5. The oxygen transport membrane assembly of claim 1 wherein the at least one aluminum oxide layer is formed by applying a slurry based diffused aluminide coating composition comprising a chromium-aluminum alloy and a halide activator on the reactor structure and curing the aluminide coating to form the at least one aluminum oxide layers.

6. The assembly of claim 1 wherein the at least one layer of high emissivity material further comprises an aluminum-phosphate layer having a plurality of carbon encapsulated within an aluminum-phosphate matrix to provide the chromium diffusion barrier and high emissivity.

7. The oxygen transport membrane assembly of claim 6 wherein the aluminum-phosphate layer is an ultra thin film having a thickness of less than or equal to about 2 microns.

8. The assembly of claim 1 wherein the at least one layer of high emissivity material further comprises a high porosity ceramic-oxide layer.

9. The oxygen transport membrane assembly of claim 1 wherein the reactor structure has an interior surface with a surface treatment comprising an oxidation resistant layer or other protective layer that mitigates adverse reactions of any ceramic materials or catalytic materials on the interior of the reactor.

10. The oxygen transport membrane assembly of claim 1 wherein the wherein the reactor structure is a ceramic assembly having a wash-coat catalyst applied to an interior surface and wherein the interior surface of the reactor structure has a surface treatment comprising an oxidation resistant layer or other protective later that mitigate adverse reactions of any ceramic materials or catalytic materials on the interior of the reactor.

11. The oxygen transport membrane assembly of claim 1 further comprising at least one metal containing component in addition to the reactor structure and wherein the at least one metal containing component includes a coating or overlay system comprising an oxidation resistant layer or a chromium barrier layer or both.

12. The oxygen transport membrane assembly of claim 1 wherein the reactor structure is a catalyst containing reformer tube configured to produce a synthesis gas product stream from a feed stream in the presence of the radiant heat from the oxygen transport membrane tubes.

13. The oxygen transport membrane assembly of claim 1 wherein the reactor structure is a heating tube configured to produce a heated gas product stream from the radiant heat from the oxygen transport membrane tubes.
